(19) United States
(12) Patent Application Publication
(10) Pub. No.: US 2022/0357003 A1
(43) Pub. Date: Nov. 10, 2022

(54) ENCLOSURE FOR RECESSED LIGHT

(71) Applicant: Pure Forms, LLC, San Antonio, TX (US)

(72) Inventors: Ben Mathews, San Antonio, TX (US); John Fiegener, Marblehead, MA (US)

(73) Assignee: Pure Forms, LLC, San Antonio, TX (US)

(21) Appl. No.: 17/736,752

(22) Filed: May 4, 2022

Related U.S. Application Data
(60) Provisional application No. 63/183,918, filed on May 4, 2021.

(51) Int. Cl. F21S 8/02; F21V 21/04; F21V 29/75; F21V 23/00

(52) U.S. Cl. CPC F21S 8/024; F21S 8/026; F21V 21/042; F21V 29/75; F21V 23/007

(57) ABSTRACT

An enclosure for recessed lighting, comprising a lateral wall, a top wall and a removable and re-attachable enclosure base, the enclosure base includes a light source, power supply, optic, heat sink and a collar. The enclosure may include an integral junction box, or hangar bar bracket, and one or more cutouts to reduce the possible interference between enclosure and joists in the installation vicinity. The enclosure may be made out of a 3D printable material, moldable material or plastic to facilitate ease of manufacture, reduction of parts, reduction of weight, and elimination of finish steps, such as paint. Multiple enclosures may be stacked for shipping or storage, and hanger bars may be affixed to the lateral wall for installation of the enclosure in a ceiling or wall without the need for a secondary bracket.

### PRIORITY STATEMENT UNDER 35 U.S.C. § 119 & 37 C.F.R. § 1.78

This non-provisional application claims priority based upon prior U.S. Provisional Patent Application Ser. No. 63/183,918 filed May 4, 2022, in the names of Ben Mathews and John Fiegener entitled “ENCLOSURE FOR RECESSED LIGHT,” the disclosures of which are incorporated herein in their entirety by reference as if fully set forth herein.

### FIELD OF INVENTION

The present disclosure generally relates to the field of lighting and lighting fixtures mounted in a ceiling or wall. More particularly, the present subject matter relates to enclosures for recessed lighting.

### BACKGROUND OF THE INVENTION

Recessed lights, also known as downlights or can lights, are a type of lighting fixture installed in the ceiling or wall. Recessed lighting is typically installed between ceiling or wall joists behind drywall or another substrate. Recessed lights are designed to sit flush with the surface of the ceiling or wall for a sleek and polished finish. The enclosure and electrical wiring components are hidden, and the luminous assembly appears to glow from within the. enclosure

The enclosure frequently houses the junction box, LED assembly, power supply, and an adjustment/rotation mechanism, if required. The enclosure is typically installed between steel or wooden joists behind the finished visible ceiling or wall. The enclosure houses the bulk of the recessed lighting fixture and contains the electrical connections required to power the fixture. Enclosures come in various sizes based on the diameter of the circular opening where the light source is installed. Some enclosures can be air-tight, which means it will not allow air to escape into the ceiling or attic, thus reducing both heating and cooling costs.

The enclosure serves two primary purposes: (1) to house the LED driver, electrical connections and junction box as required by Underwriters Laboratories (UL) code; and (2) to ensure that no flammable materials come into contact with the hot lighting fixture. If the ceiling is insulated, the recessed light fixtures must be Insulation-Contact (IC) rated or a gap of 6″ must be maintained around the enclosure.

The industry has standardized around enclosures made from steel or aluminum sheet metal due to their inherent fire prevention properties, durability during installation, and the general language guidance found in UL 1598. While metal is inherently fire-resistant, polymeric materials, including plastics, are not. Accordingly, enclosures made from polymeric materials may be required to meet a standard that is more stringent than that required by metal enclosures.

Additionally, it is important to take into account the ability for the finished products to be packed into as small a volume as possible for storage and shipping purposes, including to reduce shipping costs.

### SUMMARY OF THE INVENTION

The present disclosure covers systems for enclosure recessed lighting and methods by which such systems for enclosure recessed lighting may be fabricated.

Many of the issues inherent in the prior art may be addressed by an enclosure that is formed predominately of polymeric materials, namely plastic, which may incorporate features to allow for the installation of parts, or joining of multiple enclosures together, without the need for tools or fasteners.

Accordingly, an object of the present disclosure is to provide an enclosure for recessed lighting that provides benefits over the prior art due to its structural design, as well as due to the prominent use of plastic components, which allows for easier and less expensive fabrication of the system, reduces the number of parts, and provides additional beneficial features which will be discussed in more detail hereinbelow.

Embodiments of the system may allow for large portions of their structure to be formed of polymeric materials, including plastic. The polymeric components may be fabricated by injection molding or other suitable processes, which may allow for easier, faster, and cheaper fabrication of the system when compared to others known in the art. The design of the enclosure also allows for multiple enclosures to be stacked together, minimizing the volume required to ship large quantities of the enclosures.

Further advantages and examples of the invention will be brought out in the disclosure below, wherein the detailed description is for the purpose of fully disclosing the invention without placing limitations thereon.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF THE DRAWINGS

The novel features believed characteristic of the disclosed subject matter will be set forth in any claims that are filed in connection with this application or any of its counterparts. Although the following figures depict various examples of the invention, the invention is not limited to the examples depicted in the figures. The disclosed subject matter itself, as well as a preferred mode of use, further objectives, and advantages thereof, will best be understood by reference to the following detailed description of an illustrative embodiment when read in conjunction with the accompanying drawings, wherein:

FIG. 1 depicts a side-perspective view of an enclosure, in accordance with one embodiment of the present invention;

FIG. 2 depicts a front-perspective view of an enclosure, in accordance with one embodiment of the present invention;

FIG. 3 depicts a partial side-perspective view of an enclosure, in accordance with one embodiment of the present invention;

FIG. 4 depicts a back-perspective view of an enclosure, in accordance with one embodiment of the present invention;

FIG. 5 depicts a side-perspective view of a stack of multiple enclosures, in accordance with one embodiment of the present invention;

FIG. 6 depicts a bottom view of an enclosure, in accordance with one embodiment of the present invention;

FIG. 7 depicts a top-perspective view of an enclosure, wherein a top wall of the enclosure has been cutoff, exposing a top side of a driver/heatsink assembly, in accordance with one embodiment of the present invention;

FIG. 8 depicts a perspective view of a driver/heatsink assembly which may be retained inside of an enclosure, in accordance with one embodiment of the present invention;

FIG. 9 depicts a perspective view of two enclosures, wherein the two enclosures are connected together along an edge by a bracket, in accordance with one embodiment of the present invention;

FIG. 10 depicts a perspective view of an alternate embodiment of an enclosure, wherein a protrusion has been formed into the top wall of the enclosure to allow for additional volume therein, in accordance with one embodiment of the present invention;

FIG. 11 depicts a cross-sectional view of the embodiment of the enclosure depicted in FIG. 10, in accordance with one embodiment of the present invention.

FIG. 12 depicts a bottom view of an enclosure, in accordance with another embodiment of the present invention;

FIG. 13 depicts a top-perspective view of an enclosure, wherein a top wall of the enclosure has been cutoff, exposing a top side of a driver/heatsink assembly, in accordance with the embodiment of the enclosure depicted in FIG. 12; and

FIG. 14 depicts another top-perspective view of an enclosure, wherein a top wall of the enclosure has been cutoff, exposing the opposite top side of a driver/heatsink assembly, in accordance with the embodiment of the enclosure depicted in FIG. 12.

### DESCRIPTION OF THE PREFERRED EMBODIMENTS

The present invention is directed to improved methods and systems for, among other things, enclosures for recessed lighting(also referred to as recessed housings). The configuration and use of the presently preferred embodiments are discussed in detail below. It should be appreciated, however, that the present invention provides many applicable inventive concepts that can be embodied in a wide variety of contexts other than enclosures for recessed lighting. Accordingly, the specific embodiments discussed are merely illustrative of specific ways to make and use the invention, and do not limit the scope of the invention.

Reference now should be made to the drawings, in which the same reference numbers are used throughout the different figures to designate the same components.

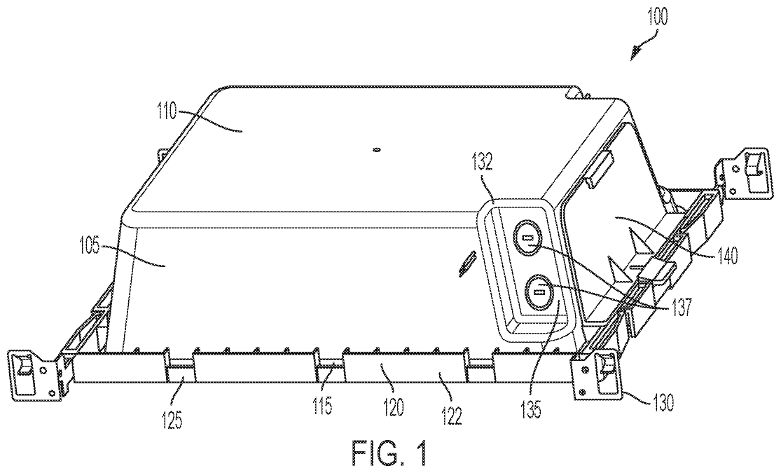

FIG. 1 provides a side-perspective view of an embodiment of enclosure 100. Lateral wall 105 can be seen encircling an interior volume. Top wall 110 is affixed to and extends between the entirety of the top edge of lateral wall 105. Flange 115 may extend outward from the bottom edge of lateral wall 105. Lip 122 may extend orthogonally from a distal edge of flange 115. Lip 122 may comprise a plurality of vertical elements 120 and 125. Vertical elements 120 and 125 may vary in dimension. Taller vertical elements 120 and shorter vertical elements 125 may alternate with one another in a manner that allows them to interlock with the vertical elements of an adjoining enclosure. One or more hanger bars 130 may each be mechanically connected to lip 122.

In some embodiments, hanger bar 130 may be secured to enclosure 100 such as by flange 115 and clip 126 which are integrated into enclosure 100. Hanger bars 130 may be positioned opposite one another at opposite ends of enclosure 100 and secured to enclosure 100 using clip 126. In addition, various embodiments of enclosure 100 may be configured to enable hanger bars 130 to be installed widthwise or lengthwise.

An integral junction box 135 with knockouts 137 may extend from a portion of lateral wall 105 and may comprise a side that is coplanar with top wall 110. One or more cutouts 132 may be set into lateral wall 105 and top wall 110 to reduce the possible interference between enclosure 100 and any joists in the area in which enclosure 100 is to be installed. In some embodiments, one or more cutouts 132 may be positioned around junction box 135.

Junction box cover 140 can be seen in a closed configuration in which it is occluding an aperture in junction box 135. A gasket (not shown) may be positioned between the wall of junction box 135 surrounding the aperture, and junction box cover 140 in order to form a seal therebetween. In some embodiments, the gasket may be overmolded onto junction box cover 140 or junction box 135. Junction box 135 may comprise one or more knockouts 137 which may provide access for electrical connections into and out of junction box 135. Knockouts 137 may be set into the side of junction box 135 facing cutout 132.

Embodiments of enclosure 100 may be largely formed of injection molded materials, 3D printable materials, or polymeric materials, namely plastic. Plastic elements of enclosure 100 may include lateral wall 105, top wall 110, flange 115, lip 122, vertical elements 120 and 125, integral junction box 135, and junction box cover 140. In certain embodiments one or more of these components may be formed from a single piece of moldable or printable material such as plastic.

Importantly, the plastics used in the present invention must be suitable for the intended application. For example, the plastic material used to manufacture embodiments of the present invention may be required to meet certain thermal requirements, such as passing an “abnormal overlamping operation test for incandescent luminaires with polymeric housings or enclosures” as specified in UL 1598, which requires an enclosure with the largest possible wattage lamp the enclosure accommodates to be operated for a minimum of 7.5 hours without ignition of the plastic material or exposure of live parts within the enclosure.

The plastic material must also pass rigorous mechanical tests. For example, when all live parts are insulated or permanently spaced more than 0.8 mm (0.032 inches) from the enclosure, the plastic enclosure material shall: (i) have a minimum 5 VA flammability rating (i.e., burning stops within 60 seconds on a vertical part not allowing for drops of plastic that are not in flames) or comply with the five-inch flame test of UL 1598 Clause 16.3; (ii) have a temperature rating equal to or greater than its maximum operating temperature in the enclosure; (iii) comply with the polymeric impact test described below for the parts that can be subject to impact after installation; (iv) comply with the mold stress-relief (thermal) test for molded or formed thermoplastic material; (v) comply with the abnormal overlamping operation test described above; and (vi) be resistant to UV radiation where the material is exposed to the sun or to fluorescent or unjacketed metal halide light sources.

Under the polymeric impact test referenced above, the test samples are first conditioned by placing them in an environment in accordance with the following table for at least 3 hours prior to the test:

### Sample Conditioning

| Location marking | Preconditioning temperature |
|---|---|
| Dry | 23 ± 2.0 C. |
| Damp | 0.0 ± 2.0 C. |
| Wet | −35 ± 2.0 C. |

The sample enclosures are then held in place and subjected to a single 7 J (5 ft·lb) impact falling through a vertical height of 1.29 m (4.24 ft), on surfaces being tested.

Those having skill in the art will readily acknowledge that the use of 3D printable or moldable materials such as plastic in the enclosure of the embodiments described herein is novel and nonobvious. Recessed downlight enclosures have routinely been made out of metal since their inception, and standards for electrical enclosures almost universally contemplate the use of metal as the fabrication material. In those instances in which a standard contemplates that a portion of an enclosure may be made out of plastic, the requirements are exceedingly rigorous. For example, UL 1598 includes the following requirements for plastic enclosures:
1. Enclosures must comply with a compression test in which the enclosure is placed on a flat horizontal surface and a 111 N (25 lb) force is applied, using a rod with a 25.4 mm (1 in) diameter face, to the center of the surface being tested for 1 min. The test results are acceptable if the electrical spacing inside the enclosure has not been disrupted and the uninsulated parts inside the enclosure remain accessible; and
2. Enclosures must comply with a mold stress relief test in which a sample of the complete thermoplastic enclosure is placed in a circulating air oven and maintained at a temperature 10° C. higher than the maximum temperature measured on the surface of the enclosure during the normal temperature test but in no case less than 70° C., for a period of 7 hours.

While the use of plastic in various embodiments of the present invention presents significant challenges, there are numerous benefits as well. For example, many plastics are less expensive than the metals generally used to make such enclosures (e.g. steel and aluminum). Therefore, by forming a large portion of enclosure 105 from plastic it is possible to significantly reduce the material cost, and number of pieces, for fabrication of such enclosures. Plastics are generally also lighter than such metals so the use of plastic components may significantly reduce the weight of such enclosure units, which may provide for reduced costs when shipping large quantities of such enclosures. This reduction in weight may be particularly beneficial due to the tendency for these types of components to be manufactured overseas.

Moreover, there is a strong preference in the industry for the enclosure to be black on the inside so that parts are not visible when viewing the underside of the enclosure from the room side when the light source is off. A black interior also prevents light from bouncing around on the interior when the light is on, thereby causing the only viewable element inside the housing to be the optic and light source. Plastic has the inherent advantage of allowing the enclosure be created in a black color without the need for a secondary finishing process, such as paint).

Another feature of various embodiments of the present invention is that the enclosure is suitable for installation into poured concrete. While many embodiments described above contemplate installation of the enclosure in ceiling or wall, there are many instances in which it may be desirable or useful to install an enclosure in a concrete ceiling, wall or floor. However, conventional metal enclosures are entirely unsuitable for such applications because chlorides are generally present in appreciable concentrations in concrete and the concrete is also high in alkali content and, as a result, metals will rapidly corrode. Moreover, metal enclosures are manufactured with seams, gaps and openings which would allow even a viscous material to flow into the enclosure, thereby rendering the enclosure unusable without the added use caulk or silicon to properly seal the enclosure.

One of the plastic materials suitable for use in connection with embodiments of the present invention is PVC-MOA which is available through Kingfa Technology Co., Ltd. The plastic materials of enclosure 100 may be fabricated by means of injection molding or 3D printing, which may allow for faster and less expensive fabrication when compared to stamping and bending sheet metal, as is generally taught in the art.

In some embodiments, part geometry may allow for enclosures to be stacked together in an efficient manner, thereby reducing the space required to store multiple enclosures and providing for lower shipping costs.

Those skilled in the art will appreciate that this stacked configuration is particularly efficient when the enclosures are made using 3D printing. 3D printing technology is inherently different from traditional injection molding, thermoforming or machine tool processing. Using 3D printing technology, a three-dimensional enclosure is drawn in a CAD or other computer-rendered drawing. The selected material is then deposited or superimposed layer by layer in the printer until the entire enclosure is printed. 3D printing technology is a growing processing method, which is well applied in the fields of industrial modeling and manufacturing.

In the context of the various embodiments of the present invention, the application of 3D printing allows a single plastic enclosure, or a series of stacked plastic enclosures, to be printed in a printer. As can be easily appreciated, the printing of a metal enclosure is neither feasible nor practical. 3D printing of a stacked set of plastic enclosures allows for the fast, efficient, economical and reliable creation of numerous enclosures in a stackable, storable and shippable configuration. This concept, and certainly any specific implementation of this concept, is presently unknown in the art.

In some embodiments, the geometry of the enclosure may allow for optimized 3D printing of the enclosure, wherein parts of the enclosure may be nested in a 3D printer thereby allowing for more parts to be printed in a smaller printer bed volume.

Also, some embodiments of the enclosure may provide for snaplock interfacing between its constituent components, which may enable the entire assembly to go together without the need for tools or fasteners. For example, in certain embodiments, vertical elements 120 and 125 of lip 122 may be configured to interlock with their counterparts on one or more adjoining enclosures in a snaplock-type interface. In embodiments, this manner of snaplock assembly may be enabled by the elements of the enclosure, which may be formed of plastic and produced by means of injection molding.

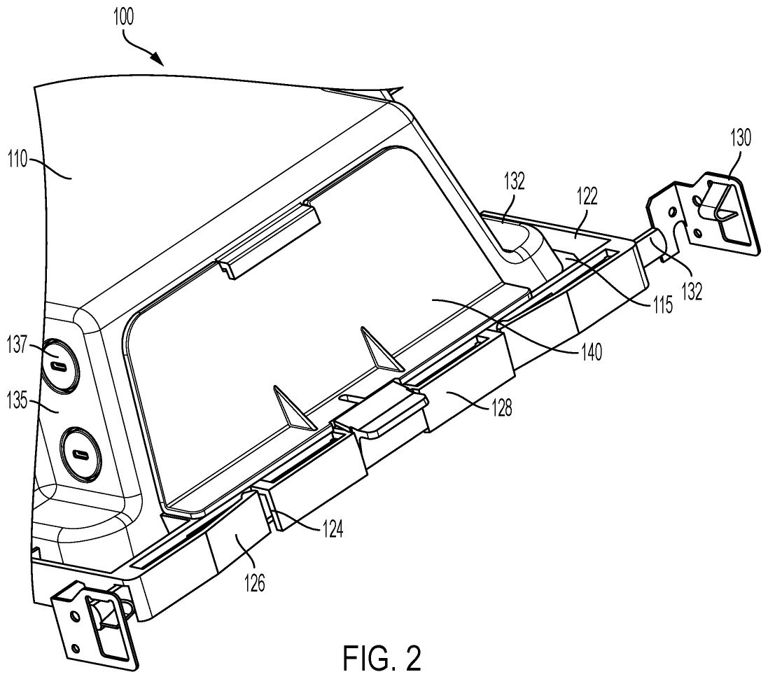

FIG. 2 provides a zoomed-in view of one embodiment of the present invention focusing on the side of enclosure 100 comprising integral junction box 135. From the view presented in FIG. 2, hangar bar 130 can be seen running along and extending from channel 124 at the corners of lip 122. This view also shows that the vertical elements of lip 122 may comprise bracket portions, such as bracket 128, and clip portions, such as clip 126. Bracket 128 and clip 126 may be attached to lip 122 and may be configured to provide for channel 124 therebetween. Channel 124 may be configured to permit insertion of hangar bar 130 without the need for tools or mechanical fasteners. Hangar bar 130 may be retained within channel 124 through friction fitting between hangar bar 130, lip 122, clip 126, and bracket 128; and may permit enclosure 100 to be supported by hangar bar 130. Clip 126 may be manipulated to temporarily reduce the magnitude of the force generated by the friction fitting between clip 126 and hangar bar bracket 130 to allow for translation of hangar bar 130 along channel 124.

Some embodiments of enclosure 100 incorporating bracket 128, clip 126 and channel 124 may permit enclosure 100 to move along hangar bar 130 and to lock in place without the need for other locking means, such as screws. Such embodiments may also obviate the need for hangar bar brackets, which are commonly used in the relevant art.

Also, some embodiments of the design may provide for a junction box cover that snaps in place due to disengageable interlocking features molded into the junction box cover and the enclosure.

In some embodiments, an overmolded gasket may be molded into the junction box cover or junction box at the time of its fabrication, thereby reducing the need to apply a separate gasket during assembly.

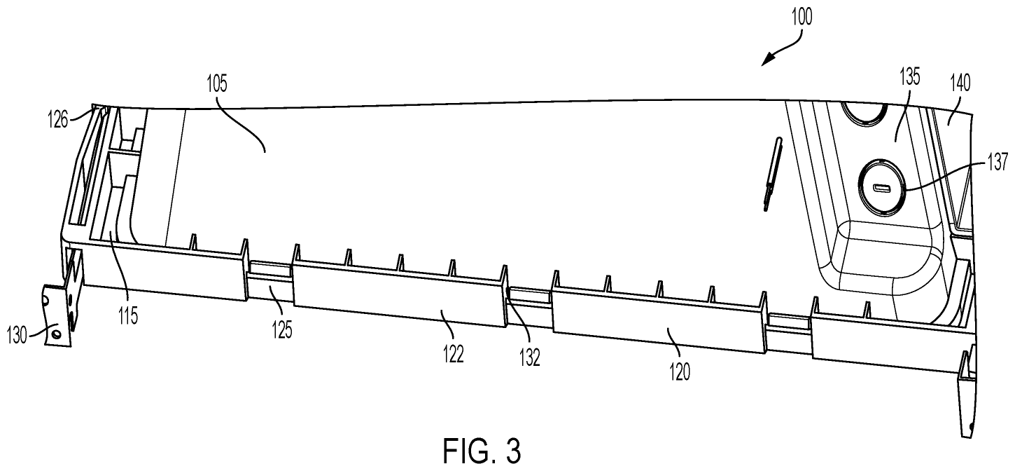

FIG. 3 shows a zoomed-in view of a bottom portion of a lateral side of lateral wall 105 of an embodiment of the present invention. Flange 115 can be seen extending from the bottom edge of lateral wall 105 and extending between lateral wall 105 and lip 122, creating a spacing therebetween. A plurality of buttresses 132 may extend between lip 122 and lateral wall 105 to provide for additional strength of the structure. In the embodiment depicted in FIG. 3 buttresses 132 are present between the tall vertical elements 120 of lip 122 and lateral wall 105, but not between the short vertical elements 125 and lateral wall 105.

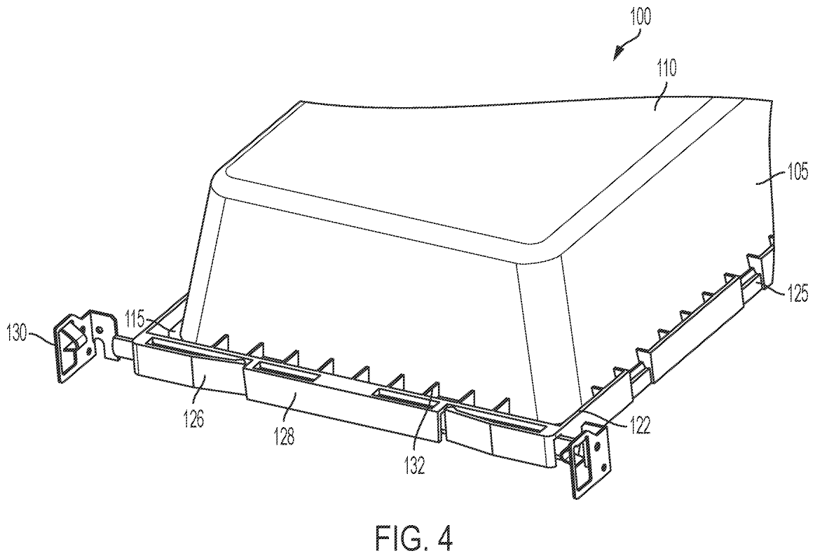

FIG. 4 depicts a zoomed-in view focusing on a back side of enclosure 100 of an embodiment of the present invention. This view shows many of the same structures for interfacing between enclosure 100 and hangar bar 130 described with regard to FIG. 2, including bracket 128 and clip 126. Buttresses 132 can also be seen extending between lip 122 and lateral wall 105.

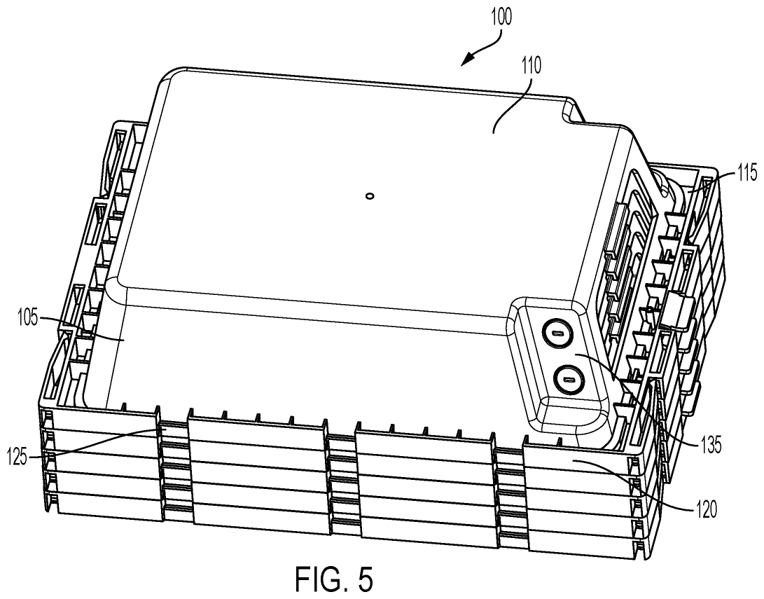

FIG. 5 depicts one embodiment of the present invention shown in a set of five stacked enclosures. In this embodiment, the circumference of the lateral wall adjacent to the top wall is less than the circumference of the lateral wall adjacent to the enclosure base, thereby allowing one enclosure to be stacked on another enclosure in order to minimize the volume required to store and ship large quantities of such enclosures. Stacking of enclosures may be achieved by inserting the protruding lateral wall and top wall portions of a first enclosure into the recessed volume defined by the lateral wall and top wall of a second enclosure. This may be repeated as desired in order to form a stack of enclosures.

The stacking of enclosures may be facilitated by configuring lateral wall 105 such that the top edge of lateral wall 105 is shorter than the bottom edge of lateral wall 105, and by having top wall 110 not extend beyond the top edge of lateral wall 105. Stacking may also be facilitated by having lip 122, including its constituent vertical elements 120 and 125, not extend beyond a bottom surface of flange 115.

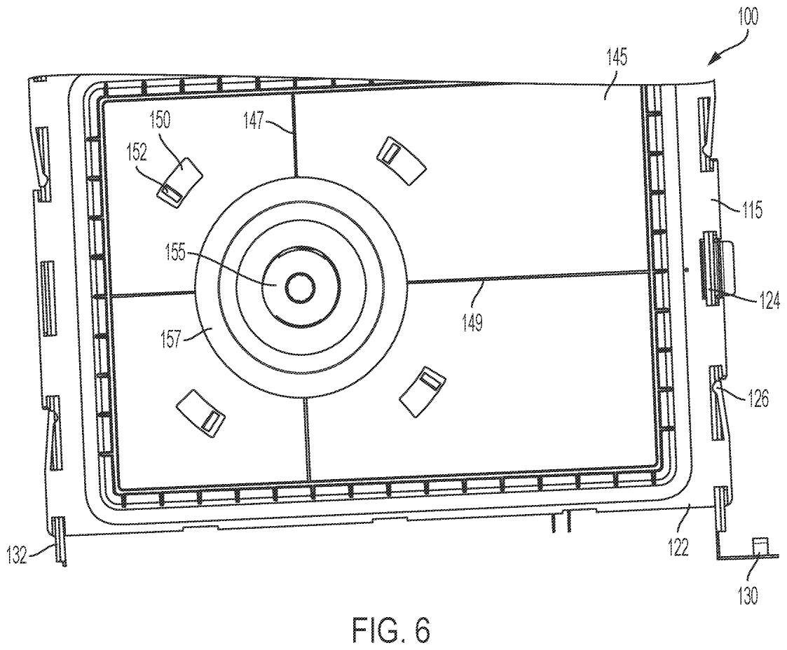

FIG. 6 shows a bottom view of one embodiment of enclosure 100. This view reveals enclosure base 145 which extends between the bottom edge of lateral wall 105, covering the recessed volume defined by lateral wall 105 and top wall 110. An aperture may be set into enclosure base 145, exposing collar 157 and socket 155. Socket 155 may be part of a driver/heatsink assembly (not shown), and is where a light element, such as a lightbulb, may be installed into enclosure 100. One or more retention means, such as rotational locking element 150 and retention tab 152, may be integrated into enclosure base 145 to enable easy attachment additional components (not shown) around socket 155 and support thereof.

In some embodiments, enclosure base plate 145 may be configured to removably interface with an inner surface of lateral wall 105 and/or flange 115 in a manner that allows enclosure base plate 145 to fixedly extend across the plane formed by the bottom edge of lateral wall 105 without the need for additional fasteners. In various embodiments, enclosure base plate 145 may be secured to lateral wall 105 using a snap or friction fitting, thereby eliminating the need for tools in the (production/manufacturing) process. Affixing enclosure base plate 145 to lateral wall 105 may create an airtight and/or water tight seal between enclosure base plate 145 and the lateral wall 105.

While enclosure base 145 may be formed of plastic, collar 157 may be made of metal, to reduce the likelihood of damage to enclosure 100 during installation. Reciprocating and/or rotary cutting tools, such as a RotoZip™, are often used cut through materials into which recessed lighting is being installed in order expose the light element. Often this is done when the recessed lighting enclosure is already set in place. Such cutting tools can quickly and easily bite into and damage or destroy plastic components of the recessed lighting enclosure with which they come into contact. Using a metal collar can help guard the surrounding plastic components from such damage during this process.

In some embodiments, a piece of trim (not shown) and baffle or reflector (not shown) may be installed inside of or around collar 157 such that collar 157 is not visible after the final instillation of the recessed lighting fixture is complete.

Also in some embodiments, enclosure base 145 may comprise line grids 147 and 149, which may be used to facilitate the lining up of multiple enclosures during instillation in order to maintain their respective lighting elements along a single line. In those embodiments in which the enclosure base 145 is formed of plastic, line grids 147 and 149 may be formed into enclosure base 145 during fabrication by injection molding.

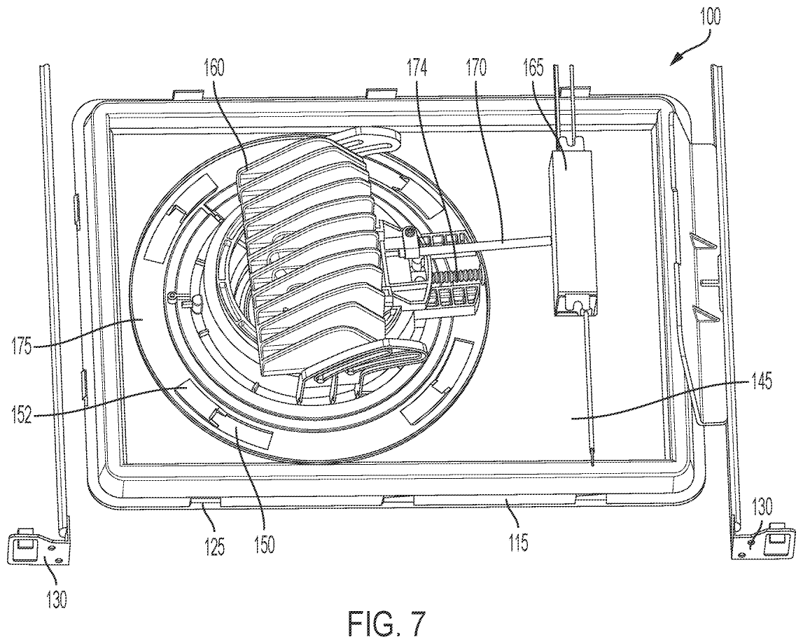

FIG. 7 provides a top view of one embodiment of enclosure 100, wherein top wall 110 has been cut off exposing the recessed enclosure formed by top wall 110 and lateral wall 105. In the embodiment depicted by FIG. 7, driver/heatsink assembly 160 and power supply 165 may be seen retained within the recessed enclosure. Driver/heatsink assembly 160 may be installed by rotational locking interface with rotational locking elements 150 and retention tabs 152 without the use of a tool or separate fasteners. Driver/heatsink assembly 160 may comprise socket 155 and may be used to absorb and safely radiate heat generated by the operation of a light element (not shown) that has been connected to socket 155.

Some embodiments of enclosure 100 may provide for the enclosure to serve as a junction box without the need for a separate compartment for line voltage components.

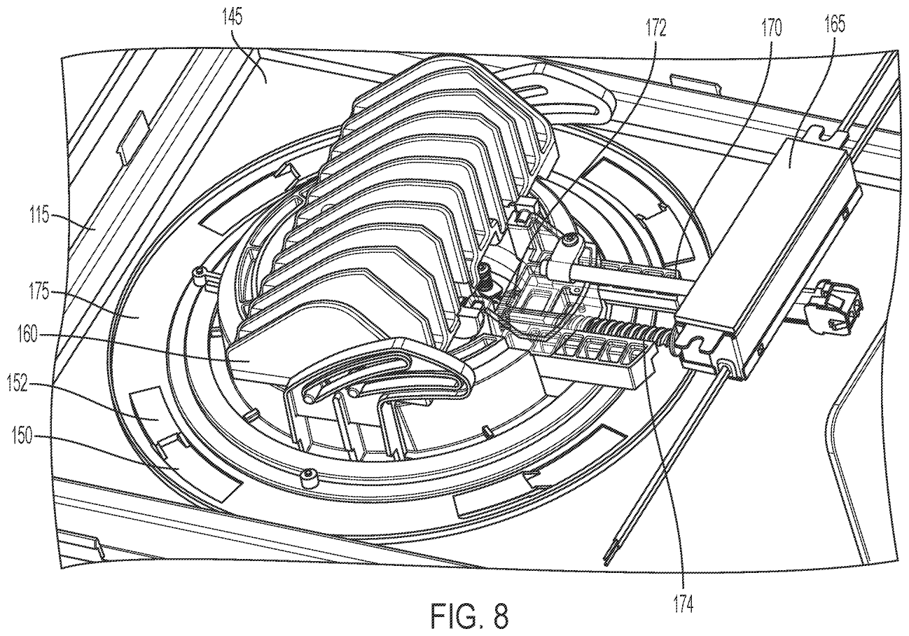

FIG. 8 is a zoomed-in view of the view presented in FIG. 7 that focuses in on driver/heatsink assembly 160 and power supply 165. The attachment means (here rotational locking element 150 and retention tab 152) can be seen in more detail, including the way that it allows for their mechanical interfacing with corresponding holes in collar 175, thereby enabling rotatable attachment and detachment of collar 175 and driver/heatsink assembly 160.

The view provided in FIG. 8 also shows drive screw 174 which may provide for translation of driver/heatsink assembly 160 along a linear axis responsive to the rotation of thumb wheel 172. Rotation of thumb wheel 172 in a first direction, for example clockwise, may engage drive screw 174 to translate driver/heatsink assembly 160 along an axis in a first direction, and rotation of the thumb wheel 172 in a second direction, for example counter-clockwise, may engage drive screw 174 to translate driver/heatsink assembly 160 along the axis in a second direction opposite the first direction.

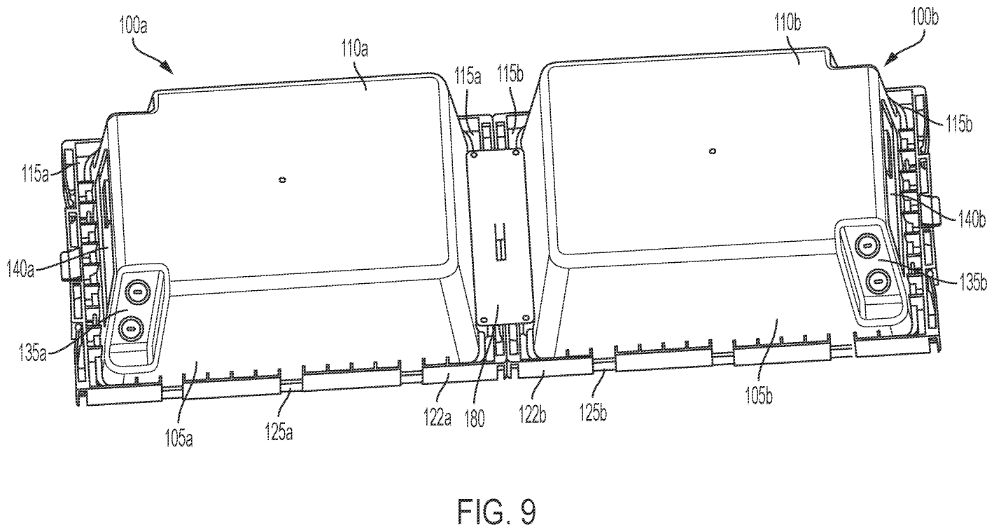

FIG. 9 depicts a top-side perspective view of enclosures 100a and 100b abutting one another along a side of their respective lips 122a and 122b. Connecting bracket 180 operates to couple enclosure 100a to enclosure 100b by creating a mechanically interface between their respective lips 122a and 122b (including their constituent vertical elements 120a/b and recesses 124a/b) and flanges 115a and 115b.

Connecting bracket 180 provides for a simple attachment mechanism that allows two enclosures to be linked together and lined up with one another.

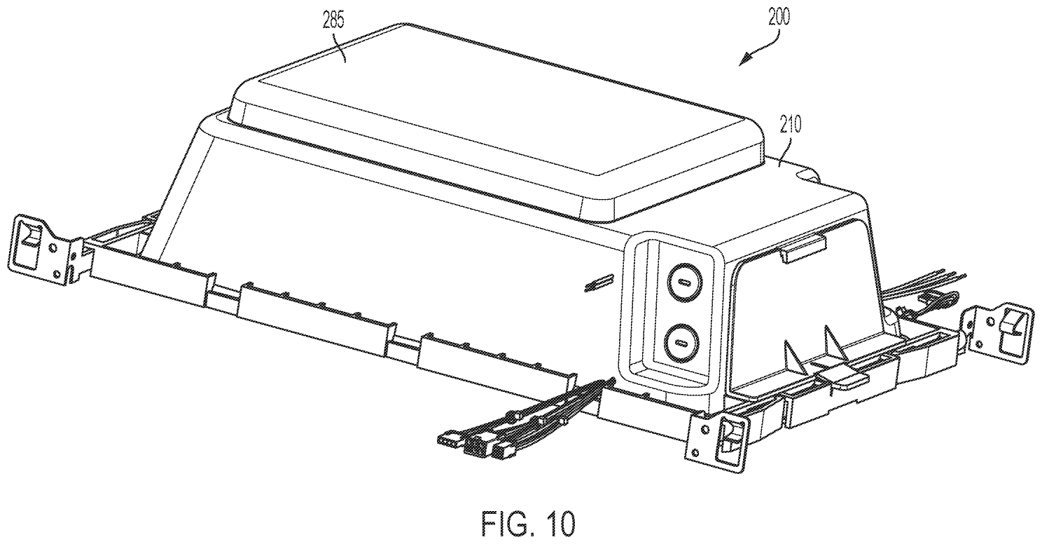

FIG. 10 depicts an alternate embodiment of an enclosure 200, wherein top wall 210 comprises protrusion 285. Protrusion 285 may extend above the portion of top wall 210 that is connected to the top edge of lateral wall 105, to provide for the increased volume in the recessed volume defined by lateral wall 105 and top wall 210. The increased volume inside of enclosure 200 created by protrusion 285 may be used to facilitate the installation and retention of large driver/heatsink assemblies (not shown).

While protrusion 285 may generally be positioned above the aperture in the enclosure base so that it may accommodate a driver/heatsink assembly, which tend to be positioned close to the socket in which a light element may be installed, embodiments of protrusion 285 may be located in any suitable position. Additionally, protrusion 285 may be of any dimensions suitable for its intended purpose.

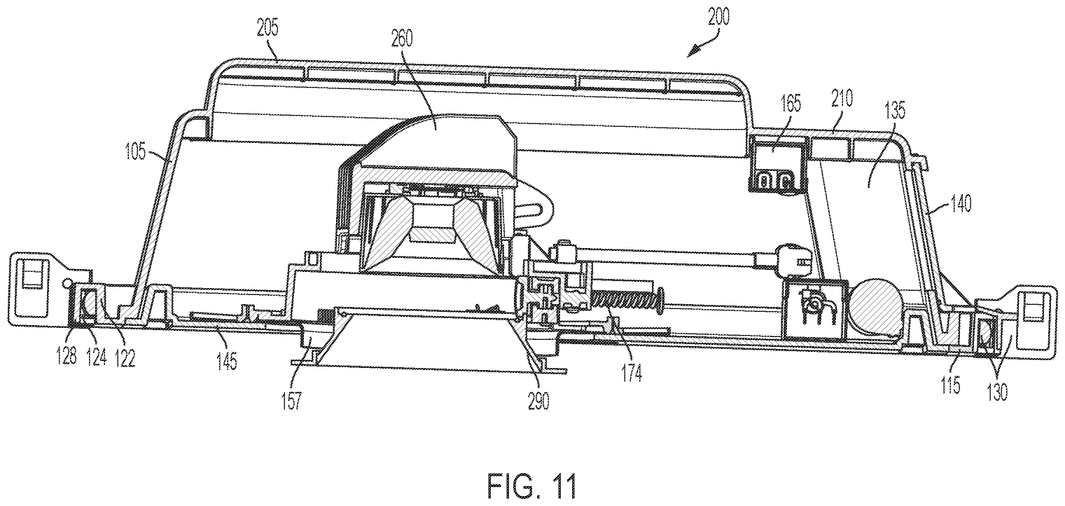

FIG. 11 shows a cross-sectional side view of enclosure 200. In this view a large driver/heatsink assembly 260 can be seen installed inside of the recessed volume of enclosure 200. Trim 290 can be seen extending from driver/heatsink assembly 260 and out of the center of collar 157, which is set into aperture of enclosure base 145.

The cross-sectional view in FIG. 11 also provides a better understanding of the extent of the recessed volume inside of enclosure 200. As can be seen, protrusion 285 may provide for expansion of the recessed volume beyond the top edge of lateral wall 105 in order to fully retain large driver/heatsink assembly 260, which would not be able to fit into the embodiment of housing 100 depicted in many of the earlier figures.

The cross-sectional view presented in FIG. 11 also depicts how embodiments of an enclosure, including enclosure 200, may provide for junction box 135 to be integrated into the enclosure. In the embodiment of enclosure 200 depicted in this junction box 135 may not have a junction box divider plate dividing the interior volume of junction box 135 from the rest of the recessed volume of enclosure 200.

In some embodiments, there may be a junction box divider plate (not shown) positioned between and separating the interior volume of junction box 135 and the rest of the recessed volume inside of enclosure 200. In such embodiments incorporating a junction box divider plate, an aperture may be configured in the junction box divider plate through which wiring may be passed. Such embodiments may additionally comprise a junction box divider plate cover, similar to junction box cover 140, which may be configured to removably occlude the aperture in the junction box divider plate.

FIG. 6 shows a bottom view of another embodiment of enclosure 100. This view again shows enclosure base 145 which extends between the bottom edge of lateral wall 105, covering the recessed volume defined by lateral wall 105 and top wall 110. Again, an aperture may be set into enclosure base 145, exposing collar 157 and socket 155. Socket 155 may be part of a driver/heatsink assembly (not shown), and is where a light element, such as a lightbulb, may be installed into enclosure 100. One or more retention means, such as rotational locking element 150 and retention tab 152, may be integrated into enclosure base 145 to enable easy attachment additional components (not shown) around socket 155 and support thereof.

In this particular embodiment, a junction box is molded into enclosure base 145. Access panel 192 is configured into the enclosure base 145 using connectors 194. The connectors may be screws, interlocking fasteners or other connectors known in the art. The enclosure base 145 itself may still be configured to removably interface with an inner surface of lateral wall 105 and/or flange 115. In addition, enclosure base 145 may still comprise line grids 147 and 149, which may be used to facilitate the lining up of multiple enclosures during instillation in order to maintain their respective lighting elements along a single line.

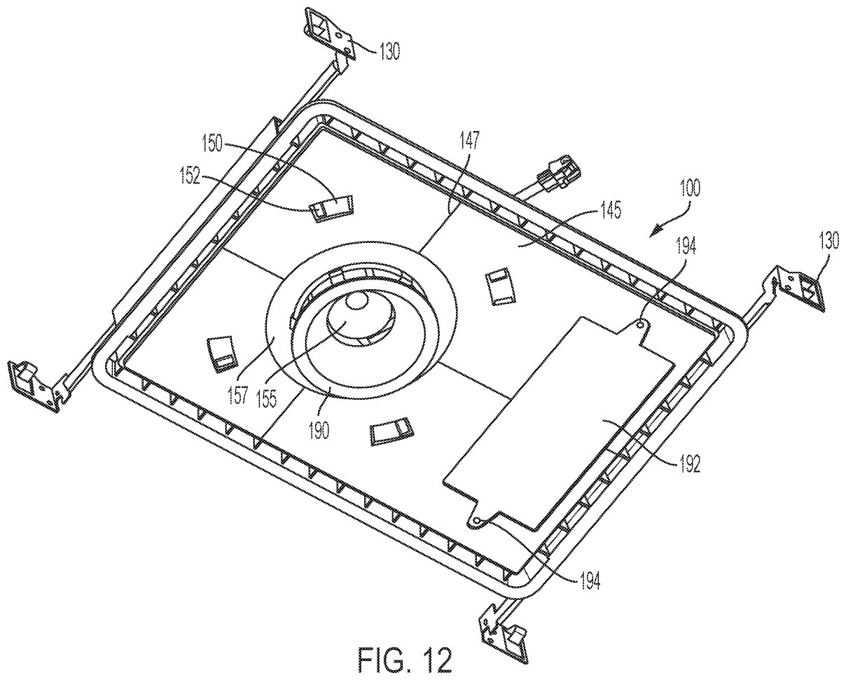

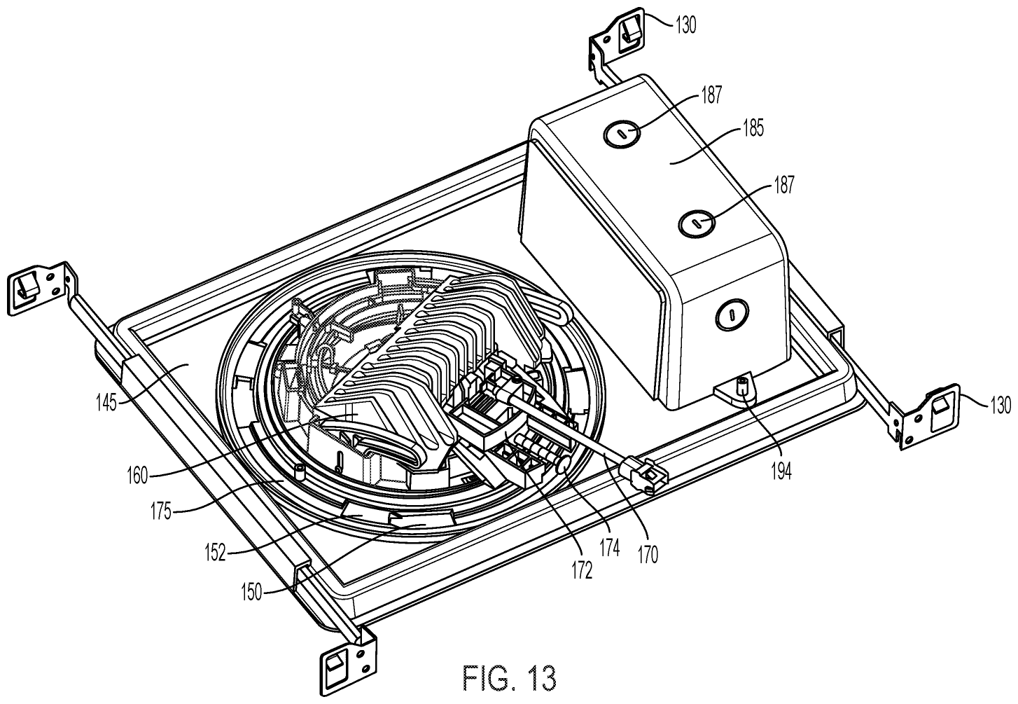

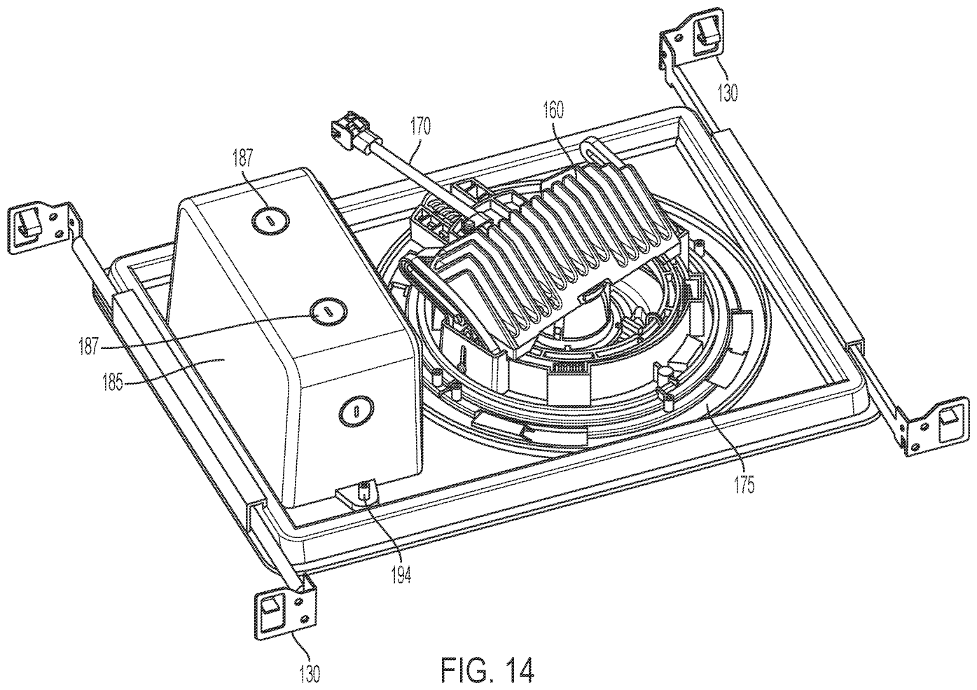

FIG. 13 and FIG. 14 provide opposite sides of a top view of the embodiment of FIG. 12, wherein top wall 110 has been cut off exposing the recessed enclosure formed by top wall 110 and lateral wall 105. As described above, junction box 185 is molded into enclosure base 145. Knockouts 187 are configured in junction box 185, thereby permitting wiring to extend from the top side of the enclosure into junction box 185 so that the wiring is accessible from the underside (or room side) of the enclosure. This allows a unitary enclosure base/junction box that is efficient to produce and eliminates the need to attach a separate junction box, and also enhances functionality by making the wiring and driver accessible from the room-side of the enclosure to facilitate installation, repairs or maintenance. As in some prior embodiments, the driver/heatsink assembly 160 may be installed by a rotational locking interface with rotational locking elements 150 and retention tabs 152 without the use of a tool or separate fasteners, and driver/heatsink assembly 160 may comprise socket 155 and may be used to absorb and safely radiate heat generated by the operation of a light element (not shown) that has been connected to socket 155.

In the embodiment described immediately above, junction box 187 is molded directly into, and made a part of, enclosure base 145. As will be appreciated by those having skill in the art, an opening may be configured in enclosure base 145 and a standard, commercially available junction box could be placed over the opening to achieve a configuration similar to that described above. In this instance, the standard, commercially available junction box would be affixed to enclosure base 145 using screws, fasteners or other connectors known in the art. The standard, commercially available junction box may be configured with knockouts which would also permit wiring to extend from the top side of the enclosure into the junction box so that the wiring is accessible from the underside (or room side) of the enclosure, thereby creating similar functionality to the molded junction box 185 described above.

As discussed hereinabove, large portions of the enclosures taught by this disclosure may be formed of 3D printable or moldable polymeric materials, including plastic. Embodiments may provide for enclosures wherein a single piece of plastic may comprise one or more of the following components: the top wall, the lateral wall, the protrusion, the flanges, the lip, the junction box, the vertical elements, the buttresses, the clips, the brackets, and the enclosure base plate. By increasing the number of components that are formed from a single piece of plastic the number of total separate components required for the enclosure may be reduced.

The plastic components of the various embodiments of the enclosures discussed above may be fabricated through suitable plastic fabrication methods that are known in the relevant arti, such as by injection molding.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of enclosures for recessed lights known in the art, the detailed embodiments are intended to be illustrative only and should not be taken as limiting the scope of the invention. Rather, what is claimed as the invention is all such modifications as may come within the spirit and scope of the following claims and equivalents thereto.
None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.
To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the particular claim.

What is claimed is:

1. An enclosure for recessed lighting, comprising:
a lateral wall, a top wall and enclosure base, the enclosure base configured with a socket and a collar and the socket is configured to receive a light bulb;
a flange extending outwardly from a lower portion of the lateral wall having a clip configured to secure a hangar bar; and
wherein the lateral wall, the top wall and the enclosure base are all made of plastic.

2. The enclosure of claim 1, wherein the enclosure base is removably affixed to the lateral wall.

3. The enclosure of claim 2, wherein the enclosure is air tight when the enclosure base is affixed to the lateral wall.

4. The enclosure of claim 2, wherein the enclosure is water tight when the enclosure base is affixed to the lateral wall.

5. The enclosure of claim 2, wherein the enclosure may be installed in poured concrete when the enclosure base is affixed to the lateral wall.

6. The enclosure of claim 1, wherein a clip configured to secure the hangar bar forms an integral part of the enclosure.

7. The enclosure of claim 1, wherein the enclosure includes an integral junction box extending into the enclosure from a portion of the lateral wall.

8. The enclosure of claim 4, wherein a junction box cover is configured in a lateral wall through which access may be provided to the junction box.

9. The enclosure of claim 1, wherein the enclosure includes a junction box affixed to an upper side of the enclosure base.

10. The enclosure of claim 6, wherein a junction box cover is configured in the enclosure base through which access may be provided to the junction box from a room side of the enclosure.

11. The enclosure of claim 1, wherein the lip of a first enclosure may be interlocked with the lip of a second enclosure, thereby allowing two enclosures to be lined up and linked together.

12. The enclosure of claim 1, wherein one or more cutouts are incorporated into the lateral wall and the top wall to reduce interference with joists when mounting the enclosure.

13. The enclosure of claim 1, wherein the circumference of the lateral wall adjacent to the top wall is less than the circumference of the lateral wall adjacent to the enclosure base, thereby allowing one enclosure to be stacked on another enclosure.

14. The enclosure of claim 10, wherein stacking of enclosures may be achieved by inserting the protruding lateral wall and top wall portions of a first enclosure into a recessed volume defined by the lateral wall and the top wall of a second enclosure.

15. The enclosure of claim 1, wherein the enclosure base is configured with a socket and a collar.
